(19) United States
(12) Patent Application Publication
(10) Pub. No.: US 2004/0075520 A1
(43) Pub. Date: Apr. 22, 2004

(54) Strip conductor having an additional layer in a curved section

(76) Inventors: Rainer Nothhelfer, Germering (DE); Thorsten Lange, Mindelheim (DE)

Correspondence Address: Tyco Technology Resources, Suite 140, 4550 New Linden Hill Road, Wilmington, DE, 19808, US

(21) Appl. No.: 10/433,770

(22) PCT Filed: Nov. 21, 2001
(86) PCT No.: PCT/EP01/13518

(30) Foreign Application Priority Data
Dec. 14, 2000 (DE) 100 62 403.0

(51) Int. Cl. H01F 5/00

(52) U.S. Cl. 336/200

(57) ABSTRACT

A strip conductor has an additional layer (4, 8, 9) in regions (5, 6, 7) of a curved section (3). The additional layer has a smaller resistivity than the strip conductor. In this way, a more uniform distribution of the current flow transversely across the width of the strip conductor is achieved. High current densities at the curve inside (10) are therefore avoided.

The invention relates to a strip conductor which has at least one curved section comprising a strip conductor layer.

Strip conductors are used in electronic circuits to connect electrical components with one another. Furthermore, it is known to arrange strip conductors in the form of a meandering resistance strip to fix a defined resistance on an electronic circuit.

In the case of a meandering strip conductor, the current density is distributed unevenly in the region of the curves, so that, for example, voltage peaks can lead to damage of the strip conductor.

To avoid disproportionately high voltages, which occur, for example, when lightning strikes, it is already known from the prior art to construct the strip conductor curves in the form of a low-resistance section of strip conductor. The construction as a low-resistance section of strip conductor offers the advantage that a raised voltage does not damage the section of strip conductor. The construction of the strip conductor curves in the form of low-resistance strip conductor sections has the disadvantage, however, that for a given resistance value the overall strip conductor length is extended, because the low-resistance strip conductor sections in the region of the strip conductor curves do not contribute to the effective resistance length.

The invention is based on the problem of producing a strip conductor with a strip conductor curve, which is of simple construction and at large voltages is protected against damage in the region of the curve.

This problem is solved by a strip conductor as defined above which in accordance with the invention is characterised in that at least one region of the curved section is provided with an additional layer, having a smaller resistivity than the strip conductor, and the at least one region is constructed such that the resistance on tracks of different radii of curvature is approximately equalised. An important advantage of the invention is that an additional or second layer which has a smaller resistivity than the material of the strip conductor, is applied to a curved section of the strip conductor in at least one region. The region is constructed so that resistance strips having different radii of curvature have an approximately equal resistance. This provides a strip conductor that is protected against voltage peaks in the region of the curve.

Further advantageous embodiments are specified in the dependent claims. Preferably, one region has a form that extends from a curve inside to a curve outside, the width of the form increasing from the curve inside to the curve outside.

In a preferred embodiment of the invention, only one region of the curved section has second layer. In this way, the curved section to which no second layer has been applied also contributes to the effective resistance length, so that the strip conductor as a whole can be made shorter to present a fixed resistance, thereby saving area.

A preferred embodiment of the region in which the second layer is formed comprises the form of a segment of a circle, the midpoint of the circle being arranged on the curve inside of the curved section.

Preferably, second layers are formed in several regions of the section, in order to achieve a current distribution that is as uniform as possible over the width of the strip conductor and at the same a time to obtain a maximum contribution of the curved section to the effective resistance length.

The invention is explained in more detail below with reference to the Figures, in which:

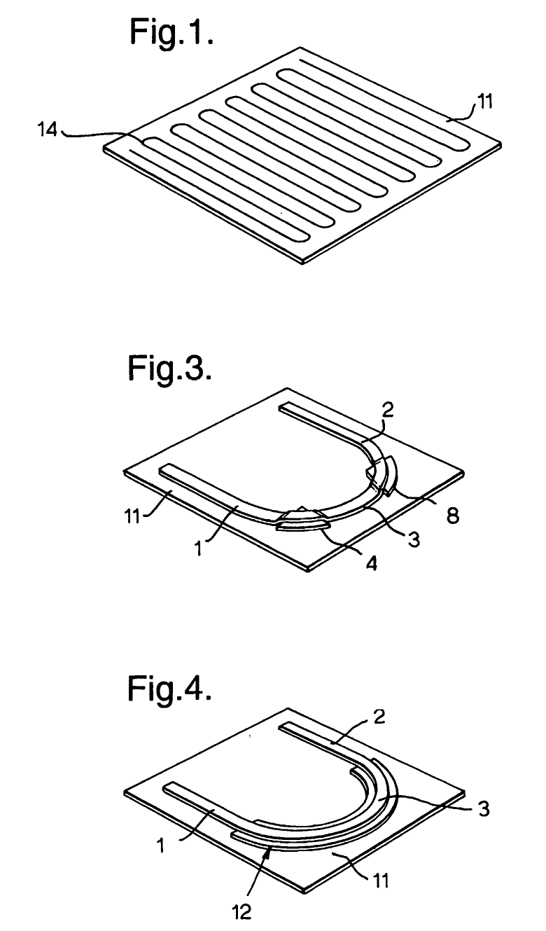

FIG. 1 schematically shows a meandering resistance strip on an electronic circuit,

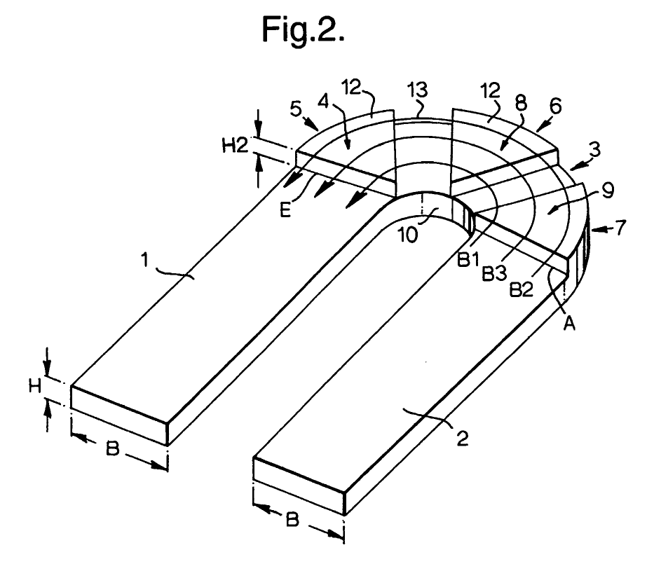

FIG. 2 schematically shows a section of the meandering resistance strip in the region of a curve,

FIG. 3 schematically shows a ceramics plate, to which the second layer and the strip conductor are applied, and

FIG. 4 schematically shows a strip conductor having a second layer beneath it for the entire curve region.

FIG. 1 shows a strip conductor having a meandering resistance strip 14, in which the resistance strip consists of straight sections and curved sections. The resistance of the resistance strip is proportional to the length of the resistance strip. The straight sections are arranged close together and the curved sections have a predetermined radius of curvature. The construction of the resistance strip as a meandering strip conductor enables a relatively long strip conductor to be formed on a given area, so that little area is needed for a given resistance. The two ends of the resistance strip are connected, for example, to electrical components.

The invention is described in the following with reference to a resistance strip, but it is possible to use the invention for any strip conductor.

FIG. 2 shows by way of non-limiting example a view in partial section of the resistance strip 14 of FIG. 1. The strip comprises a first straight section 1, a second straight section 2 and a curved third section 3, which joins the first and the second sections 1, 2 together. The first, second and third sections 1, 2, 3 preferably have the same width B of about 0.6-1.2 mm. The height H of the first, second and third sections 1, 2, 3 is likewise the same, and lies, for example, within the range from 10-15 μm. The first, the second and the third section 1, 2, 3 are approximately rectangular in cross-section and are in the form of a one-piece strip conductor, representing a (first) layer of the structure.

A first, second and third strip conductor portion 4, 8, 9 are applied to the third section 3 in a respective first, second and third region 5, 6, 7. The width of the first, second and third strip conductor portion corresponds to the width of the third section. The height of the first, second and third strip conductor portion 4, 8, 9 corresponds to a given second height H2, which lies, for example, in the range from 10 to 15 μm. The first, second and third strip conductor portion 4, 8, 9 represent a second or additional layer 12.

The shape of the first, second and third region 5, 6, 7 preferably corresponds to a segment of a circle, the segment of a circle having its circle midpoint in the region of a curve inside 10 of the first strip conductor portion 4.

The first, second and third strip conductor portion 4, 8, 9 are preferably manufactured from a second material and the first, second and third sections 1, 2, 3 from a first material, the second material having a lower resistivity than the first material. The layer thickness of the first, second and third strip conductor portion 4, 8, 9, the shape of the first, second and third region 5, 6, 7 and the resistivity of the second material are matched to the radius of curvature of the first strip conductor portion 4, so that as far as possible a uniform current distribution over the width of the third section 3 is achieved.

For uniform distribution of the current, it is an advantage if the electrical resistance along tracks of constant but different size radii for an entire curve is the same.

An outer second track B2 has a larger radius of curvature than an inner first track B1. The task of the second layer is to adjust the resistance for the different tracks B1, B2, B3 so that the track resistance for the tracks B1, B2, B3 from a start line A to a finish line E is approximately the same. The start line A represents the start and the end line E represents the end of the curved third section 3. With track resistances of equal magnitude, a uniform distribution of the current over the width of the third section 3 and a uniform distribution of the power loss is achieved, so that the third section 3 is uniformly loaded.

Instead of the circle segment form of the first, second or third region 5, 6, 7, in which a second layer 12 is applied to the third section 3, any other geometry with which the resistance in the curved third section 3 is equalised across the width of the third section 3 can be chosen. Without the second layer 12, the resistance on an outer second track B2 is greater than on an inner first track B1. Shapes of the regions 5, 6, 7 that have a width, viewed in the curve direction that increases from the curve inside 10 towards a curve outside 13 are suitable for equalisation. The regions 5, 6, 7 extend preferably from the curve inside 10 to the curve outside 13.

As first material for the first, second and third section 1, 2, 3 there is preferably used a resistance paste containing metal and glass particles, which is fired to produce the resistance strip. For the first, second and third strip conductor portions 4, 8, 9 there is used as second material, for example, a silver-containing paste, which is likewise fired to produce the first, second and third strip conductor portion. The resistivity of the second material can be selected to be as small as desired. Preferably, the second material has a sheet resistance of less than 50 mΩ/square. The resistance strip 14 having the first, second and third section 1, 2, 3 is preferably made from a material that has a sheet resistance of more than 100 mΩ/square.

FIG. 3 shows a strip conductor 1, 2, 3 that has been applied to a ceramics plate 11. The third section 3 is taken over a first and a second strip conductor portion 4, 8, the first and second strip conductor portion being manufactured from a material that has a lower resistivity than the material of the third section 3.

In a simple manufacturing process the first, second and third strip conductor section 4, 8, 9 are applied to the ceramics plate 11 by screen-printing. The strip conductor with the first, second and third section is subsequently applied by screen-printing. The ceramics plate 11 is then introduced into a drying kiln and the printed-on pastes are dried at 800° C.

FIG. 4 shows a simple embodiment of the invention, in which the entire curved third section 3 has a second layer 12 of lower resistivity beneath it. In this embodiment, the third section 3 is protected from high current densities, but the third section 3 makes no contribution to the effective resistance length and hence no contribution to the given resistance.

A preferred application of the invention is in electronic circuits for telephone apparatus or telephone systems that are protected by the inventive construction of the curves of strip conductors, for example, resistance strips, against current peaks, which occur, for example, when lightning strikes.

It will be understood by those skilled in the art that the present invention is not limited to the embodiments shown and that many additions and modifications are possible without departing from the scope of the present invention as defined in the appending claims.

1. A strip conductor, which has at least one curved section (3) comprising a strip conductor layer, characterised in that at least one region (5, 6, 7) of the curved section (3) is provided with an additional layer (4, 8, 9, 12) having a smaller resistivity than the strip conductor (1, 2, 3), and the at least one region (5, 6, 7) is constructed such that the resistance on tracks (B1, B2, B3) of different radii of curvature is approximately equalised.

2. A strip conductor according to claim 1, characterised in that the at least one region (5, 6, 7) is in the form of a segment of a circle.

3. A strip conductor according to one of claims 1 and 2, characterised in that several regions (5, 6, 7) of the section (3) are provided with an additional layer (4, 8, 9, 12).

4. A strip conductor according to any one of claims 1 to 3, characterised in that the strip conductor is in the form of a resistance strip (14), which represents a given resistance value.

5. A strip conductor according to claim 4, characterised in that the resistance strip (14) is constructed in the form of a meandering track.

6. A strip conductor according to any one of claims 1 to 5, characterised in that the additional layer (12) is applied to a ceramics plate (11) by a screen-printing process and the strip conductor (1, 2, 3) is applied to the second layer (12) and the ceramics plate (11) by a screen-printing process.

7. A strip conductor according to any one of claims 1 to 6, characterised in that the at least one region (5, 6, 7) has a width that increases from a curve inside (10) towards a curve outside (13), and the region extends from the curve inside (10) to the curve outside (13).

8. A strip conductor according to claim 7, characterised in that several regions (5, 6, 7) are provided with a second layer (12, 4, 8, 9), and are arranged spaced from one another.
